(19) United States
(12) Patent Application Publication
(10) Pub. No.: US 2025/0104287 A1
(43) Pub. Date: Mar. 27, 2025

(54) Base-Mesh Storage in ISOBMFF

(71) Applicant: Nokia Technologies Oy, Espoo (FI)

(72) Inventors: Lukasz Kondrad, Munich (DE); Lauri Aleksi Ilola, Tampere (FI); Emre Baris Aksu, Tampere (FI); Miska Matias Hannuksela, Tampere (FI); Kashyap Kammachi Sreedhar, Tampere (FI)

(21) Appl. No.: 18/889,592

(22) Filed: Sep. 19, 2024

Related U.S. Application Data
(60) Provisional application No. 63/540,766, filed on Sep. 27, 2023.

(51) Int. Cl. G06T 9/00

(52) U.S. Cl. CPC G06T 9/001

(57) ABSTRACT

An apparatus, performing an encapsulation process, accesses a coded bitstream having V-DMC, wherein the coded bitstream comprises an attribute information bitstream, a geometry information bitstream, an atlas bitstream, and a base-mesh bitstream. The apparatus stores, for later transmission, the coded bitstream having the V-DMC in a file structure compliant with an international organization for standardization base media file format (ISOBMFF). Another apparatus receives the file structure and parses, by the apparatus, the received file structure to extract the coded bitstream having the V-DMC, the coded bitstream comprising an attribute information bitstream, a geometry information bitstream, an atlas bitstream, and a base-mesh bitstream. The apparatus performs decoding with at least the base-mesh bitstream to recreate media, and stores or outputs for display the recreated media.

### CROSS-REFERENCE TO RELATED APPLICATIONS

The present application claims the benefit under 35 U.S.C. § 119 (e) of U.S. Provisional Patent Application No. 63/540,766, filed on Sep. 27, 2023, the disclosure of which is hereby incorporated by reference in its entirety. Any and all applications for which a foreign or domestic priority claim is identified in the Application Data Sheet of the present application are hereby incorporated by reference under 37 CFR § 1.57.

### TECHNICAL FIELD

Examples of embodiments herein relate generally to volumetric video coding and decoding and, more specifically, relate to base-mesh storage in ISOBMFF (International Organization for Standardization base media file format).

### BACKGROUND

Volumetric video coding and decoding are complex processes that allow a video to be encoded and transmitted from one location and received and decoded at another location. Video is a timed media, and a similar process can be used for non-timed content. One file structure for storage of this type of information is referred to as international organization for standardization base media file format (ISOBMFF). ISOBMFF is defined in ISO/IEC 14496-12. While this file structure is useful, it also has limited storage capabilities.

### BRIEF SUMMARY

This section is intended to include examples and is not intended to be limiting.

In an exemplary embodiment, a method is disclosed that includes accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

An exemplary computer program product includes a computer-readable storage medium bearing instructions that, when executed by an apparatus, cause the apparatus to perform at least the following: accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

In another exemplary embodiment, an apparatus comprises means for performing: accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

In an exemplary embodiment, a method is disclosed that includes receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

An exemplary computer program product includes a computer-readable storage medium bearing instructions that, when executed by an apparatus, cause the apparatus to perform at least the following: receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

In another exemplary embodiment, an apparatus comprises means for performing: receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

### BRIEF DESCRIPTION OF THE DRAWINGS

In the attached drawings:

FIGS. 1A and 1B are block diagrams illustrating volumetric media conversion at (FIG. 1A) an encoder and reconstruction at (FIG. 1B) a decoder, where the 3D media is converted to a series of 2D representations: base-mesh, geometry, and attributes, and where additional atlas information is also included in the bitstream to enable inverse reconstruction;

FIG. 2 is an example of a V3C bitstream and possible V3C units the bitstream may contain;

FIG. 3 is a logic flow diagram for base-mesh storage and transmission in ISOBMFF;

FIG. 4, split over FIGS. 4A and 4B, is a logic flow diagram for storing a V-DMC coded bitstream in a file structure compliant with an international organization for standardization base media file format (ISOBMFF);

FIGS. 5 and 6 are further examples of logic flow diagrams for storing a V-DMC coded bitstream in a file structure compliant with an international organization for standardization base media file format (ISOBMFF);

FIG. 7 is a block diagram of an overview including an ISOBMFF file structure for encapsulating timed V-DMC data with a single atlas with a single atlas tile;

FIG. 8 is a block diagram of an overview of structure for encapsulating non-timed V-DMC data with a single atlas with a single atlas tile;

FIG. 9 is a logic flow diagram for base-mesh decoding in ISOBMFF;

FIG. 10 is an example of a block diagram of an apparatus suitable for implementing any of the encoders or decoders described herein; and

FIG. 11 is a block diagram illustrating a system in accordance with an example.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

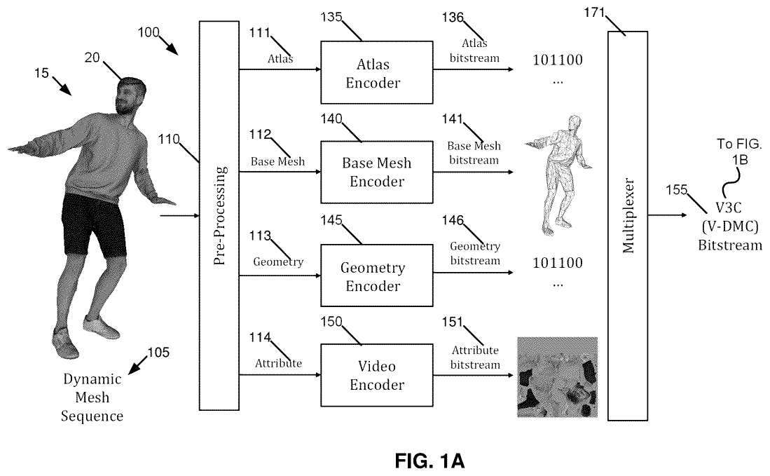

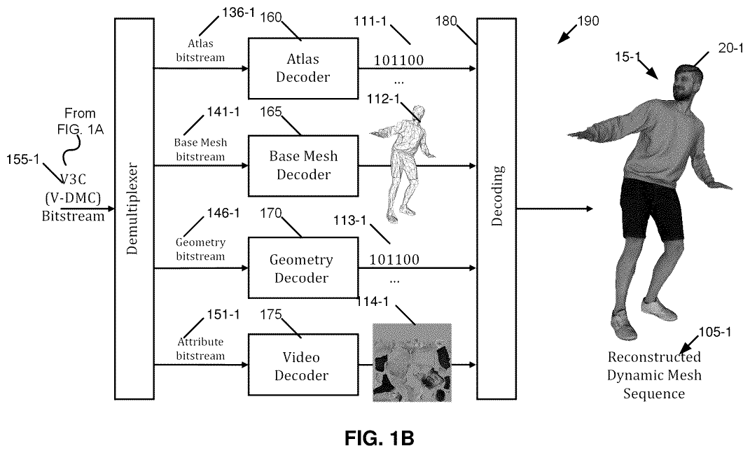

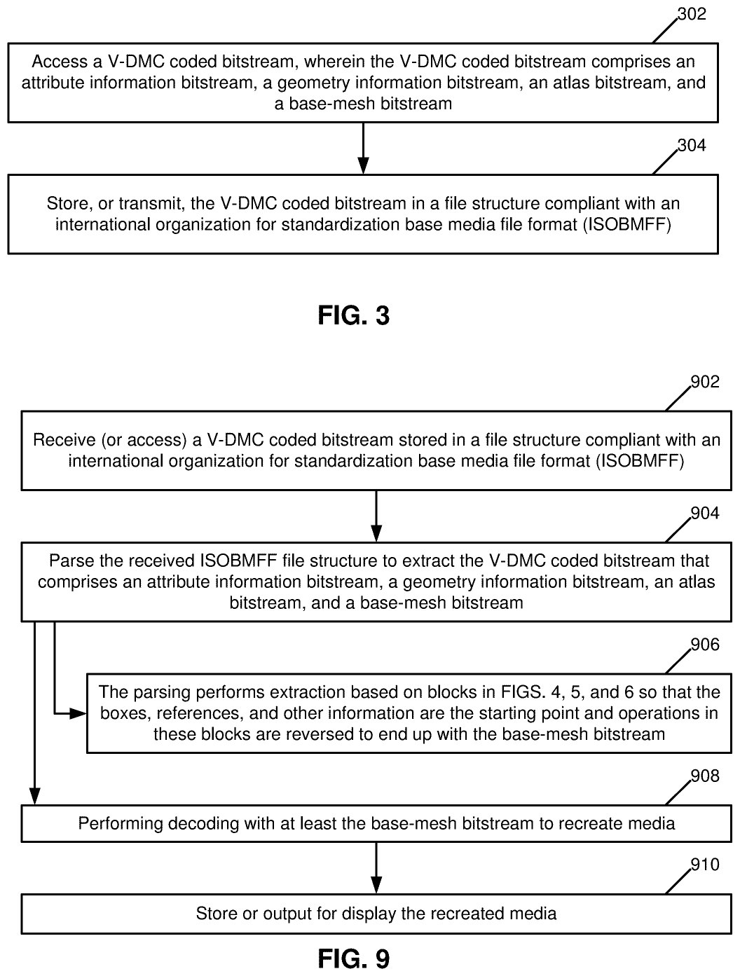

Any flow diagram (such as FIGS. 3, 4, 5, 6, and 9) or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIGS. 1A, 1B, 7, 8, and 9) may also illustrate the operation of an exemplary method, results of execution of computer program instructions embodied on a computer readable memory, functions performed by logic implemented in hardware, and/or interconnected means for performing functions in accordance with an exemplary embodiment.

An overview of some of the technical area is now presented. After the overview, problems in this area are described.

Embodiments herein may concern volumetric video capture, coding, transmission, and decoding. FIGS. 1A and 1B are block diagrams illustrating volumetric media conversion at (FIG. 1A) an encoder and reconstruction at (FIG. 1B) a decoder, where the 3D media is converted to a series of 2D representations: geometry, and attributes, and base-mesh is a simplified (low resolution) mesh approximation of the original 3D media, and where additional atlas information is also included in the bitstream to enable inverse reconstruction.

In the example of FIG. 1A, an encoder 100 is illustrated where there is a capture of 3D media, using a dynamic mesh sequence 105, of a scene 15, which includes a human being 20. The dynamic mesh sequence 105 is operated on by the pre-processing component 110. There is first a conversion of such media from their corresponding 3D representation to multiple 2D representations, also referred to as V3C components, before coding such information. The pre-processing component 110 converts 3D to 2D representations in streams of V3C components: geometry component 113; and attribute component 114. That is, such representations include the geometry, and attribute components. The pre-processing simplifies 3D media representation and creates base-mesh component 112. The base-mesh component 112 can provide a V3C decoder (as in FIG. 1B) a simplified (e.g., low resolution) mesh approximation of the original 3D media and is operated on by a base mesh encoder 140 to form a base mesh bitstream 141. The geometry component 113 contains information about the precise location, displacement of 3D data in space, and is operated on by the geometry encoder 145 to form a geometry bitstream 146. Meanwhile, the attribute component 114 can provide additional properties, e.g., color, or material information, of such 3D data, and is operated on by the video coder 150 to form an attribute bitstream. Additional atlas information 111 is also included to enable inverse reconstruction, and the atlas encoder 135 forms an atlas bitstream 136. The multiplexer 171 accepts as input the streams 136, 141, 146, and 151, which are combined to become V3C bitstream 155.

FIG. 1B illustrates a decoder 190, which performs the reverse of many of the operations of FIG. 1A. The V3C bitstream 155-1 (e.g., in case there are errors in the V3C bitstream 155) is split into its constituent component streams: atlas bitstream 136-1; base mesh bitstream 141-1; geometry bitstream 146-1; and attribute bitstream 151-1. The atlas decoder 160 forms atlas component 111-1; the base mesh decoder 165 forms the base mesh component 112-1; the geometry decoder 170 forms the geometry component 113-1; and the video decoder 175 forms the attribute component 114-1. The decoding block 180 reconstructs the 3D media to reproduce a version of the 3D media, using the reconstructed dynamic mesh sequence 105-1, of the scene 15-1, which includes a human being 20-1.

The examples of FIGS. 1A and 1B are one example of many ways to capture and represent a volumetric frame. The format used to capture and represent a volumetric frame depends on the processing to be performed on the frame, and the target application using the frame. Some exemplary representations are listed below.
1) A volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA value, or normal vectors)
2) A volumetric frame can be represented as images, with or without depth, captured from multiple viewpoints in 3D space. In other words, the frame can be represented by one or more view frames (where a view is a projection of a volumetric scene on to a plane (the camera plane) using a real or virtual camera with known/computed extrinsics and intrinsics). Each view may be represented by a number of components (e.g., geometry, color, transparency, and occupancy), which may be part of the geometry picture or represented separately.
3) A volumetric frame can be represented as a mesh. A mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e., both translational and rotational movement of their viewing pose (which includes yaw, pitch, and roll). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC, see, e.g., ISO/IEC 14496-10 (H.264/AVC), “Information technology—Coding of audio-visual objects-Part 10: Advanced video coding”, Tenth edition, 2022-11) and ISO/IEC 23008-2 (H.265/HEVC, see, e.g., ISO/IEC 23008-2 (H.265/HEVC), “Information technology—High efficiency coding and media delivery in heterogeneous environments—Part 2: High efficiency video coding”, Fourth edition 2020-08). The metadata can be coded with technologies specified in specifications such as ISO/IEC 23090-5 (see, e.g., ISO/IEC 23090-5 (E), “Information technology—Coded Representation of Immersive Media—Part 5: Visual Volumetric Video-based Coding (V3C) and Video-based Point Cloud Compression (V-PCC)”, 2022 Mar. 1). The coded images and the associated metadata can be stored or transmitted to a client that can decode and render the 3D volumetric frame.

A topic of interest is Visual Volumetric Video-based Coding (V3C)—ISO/IEC 23090-5. ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MIV (ISO/IEC 23090-12, see ISO/IEC 23090-12, “Information technology—Coded representation of immersive media—Part 12: MPEG immersive video”, First edition 2023-08). MIV (MPEG immersive video, where MPEG is Motion picture experts group) and V-PCC use number of V3C syntax elements with a slightly modified semantics. In more detail, both concepts of V3C and V-PCC are defined in ISO/IEC 23090-5. V3C is a generic mechanism, and V-PCC is one of the applications of V3C. V3C is ISO/IEC 23090-5 all sections/annexes but Annex H, whereas V-PCC is ISO/IEC 23090-5 Annex H. An example on how the generic syntax element can be differently interpreted by the application is pdu_projection_id, described below.
1) In case of V-PCC, the syntax element, pdu_projection_id specifies the index of the projection plane for the patch. There can be 6 or 18 projection planes in V-PCC, and these planes are implicit, i.e., pre-determined.
2) In case of MIV, pdu_projection_id corresponds to a view ID, i.e., identifies which view the patch originated from. View IDs and their related information are explicitly provided in MIV view parameters list and may be tailored for each content.

An MPEG 3DG (ISO SC29 WG7) group has started work on a third application of V3C—the mesh compression. It is also envisaged that mesh coding will re-use V3C syntax as much as possible and can also slightly modify the semantics.

To differentiate between applications of V3C bitstream, that allow a client to properly interpret the decoded data, V3C uses the ptl_profile_toolset_idc parameter.

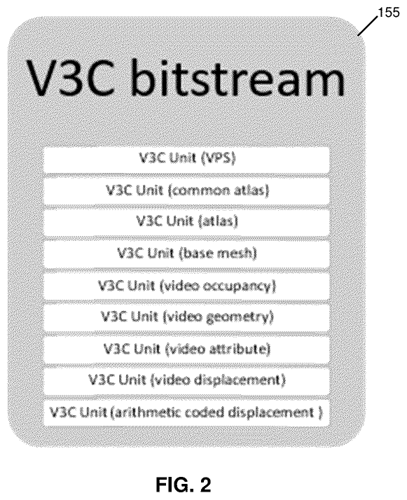

A further topic of interest is the V3C bitstream. FIG. 2 is an example of a V3C bitstream 155 and possible V3C units the bitstream may contain. The examples of V3C units are the following: VPS; common atlas; base mesh; video occupancy; video geometry; video attribute; video displacement; arithmetic coded displacement.

A V3C bitstream 155 is a sequence of bits that forms the representation of coded volumetric frames and the associated data making one or more coded V3C sequences (CVSs). CVS is a sequence of bits identified and separated by appropriate delimiters, and is required to start with a VPS, includes a V3C unit, and contains one or more V3C units with atlas sub-bitstream or video sub-bitstream. Video sub-bitstreams and atlas sub-bitstreams can be referred to as V3C sub-bitstreams. Which V3C sub-bitstream a V3C unit contains and how to interpret the unit is identified by a V3C unit header in conjunction with VPS information.

V3C bitstream can be stored according to Annex C of ISO/IEC 23090-5, which specifies syntax and semantics of a sample stream format to be used by applications that deliver some or all of the V3C unit stream as an ordered stream of bytes or bits within which the locations of V3C unit boundaries need to be identifiable from patterns in the data

A further topic of interest is Video-based Point Cloud Compression (V-PCC)—ISO/IEC 23090-5. The generic mechanism of V3C may be used by applications targeting volumetric content. One of such applications is video-based point cloud compression (ISO/IEC 20390-5). V-PCC enables volumetric video coding for applications in which a scene is represented by point cloud. V-PCC uses the patch data unit concept from V3C and for each patch assigns one of 6 (e.g., or 18) pre-defined orthogonal camera views for reprojection.

MPEG Immersive Video (MIV)—ISO/IEC 23090-12 is another topic of interest. Another application of V3C is MPEG immersive video (ISO/IEC 23090-12). MIV enables volumetric video coding for applications in which a scene is recorded with multiple RGB (D) (red, green, blue, and optionally depth) cameras with overlapping fields of view (FoVs). One example setup is a linear array of cameras pointing towards a scene. This multi-scopic view of the scene allows a 3D reconstruction and therefore 6DoF/3DoF+ consumption.

MIV uses the patch data unit concept from V3C and extends this concept by allow using application specific camera views for reprojection. In contrast to V-PCC, which uses pre-defined 6 or 18 orthogonal camera views for reprojection. Additionally, MIV introduces additional occupancy packing modes and other improvements to V3C base syntax. One such example is support for multiple atlases, for example when there is too much information to pack everything in a single video frame. It also adds support for common atlas data, which contains information that is shared between all atlases. This is particularly useful for storing camera details of the input camera models, which are frequently shared between different atlases.

Video-based dynamic mesh coding (V-DMC)-ISO/IEC 23090-29 is another topic of interest. V-DMC (ISO/IEC 23090-29) is another application form of V3C that aims on integration of mesh compression into the V3C family of standards. The standard is under development and at WD stage (MDS22775_WG07_N00611).

The retained technology after the CfP result analysis is based on multiresolution mesh analysis and coding. This approach includes the following:
1) generating a base-mesh that is a simplified (e.g., low resolution) mesh approximation of the original mesh, called base-mesh (this is done for all frames of the dynamic mesh sequence);
2) performing several mesh subdivision iterative steps (e.g., each triangle is converted into four triangles by connecting the triangle edge midpoints on the generated base mesh, generating other approximation meshes);
3) defining displacement vectors, also named error vectors, for each vertex of each mesh approximation;
4) for each subdivision level by adding the displacement vectors to the subdivided mesh vertices generates the best approximation of the original mesh at that resolution, given the base-mesh and prior subdivision levels;
5) the displacement vectors may undergo a lazy wavelet transform prior to compression; and
6) The attribute map of the original mesh is transferred to the deformed mesh at the highest resolution (i.e., subdivision level) such that texture coordinates are obtained for the deformed mesh and a new attribute map is generated.

The V-DMC generates compressed bitstreams which later on are packed in V3C units and create V3C bitstream by concatenating V3C units:
1) A sub-bitstream with the encoded base-mesh using a mesh codec.
2) A sub-bitstream with the displacement vectors:
2a) packed in an image and encoded using a video codec, or
2b) arithmetic encoded as defined in Annex J of WD ISO/IEC 23090, MDS22775_WG07_N00611
3) A sub-bitstream with the attribute map encoded using a video codec.
4) A sub-bitstream (atlas) that contains all metadata required to decode and reconstruct the mesh sequence based on the aforementioned sub-bitstreams. The signaling of the metadata is based on the V3C syntax and includes necessary extensions that are specific to meshes.

Another pertinent topic concerns a base-mesh bitstream (ISO/IEC 23090-29). A base-mesh bitstream is a sequence of bits that forms the representation of coded base meshes and associated data forming one or more coded base-mesh sequences. An elementary unit for the output of a base-mesh encoder (Annex H of ISO/IEC 23090-29) is a NAL unit.

A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0 (zero).

NAL units can be categorized into Base-mesh Coding Layer (BMCL) NAL units and non-BMCL NAL units. BMCL NAL units can be coded sub-mesh NAL units. A non-BMCL NAL unit may be for example one of the following types: a base-mesh sequence parameter set, a base-mesh frame parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded bas-mesh, whereas many of the other non-BMCL NAL units are not necessary for the reconstruction of decoded sample values.

V-DMC specifications may contain a set of constraints for associating data units (e.g., NAL units) into coded base-mesh access units. It should be noted, however, at the time of writing of the document, there was no definition of coded base-mesh access unit in WD of V-DMC specification.

Another relevant topic involves ISOBMFF-ISO/IEC 14496-12. A basic building block in the ISO base media file format (ISOBMFF) is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO base media file format, a file includes media data and metadata that are encapsulated into boxes. Each box is identified by a four-character code (4CC) and starts with a header which informs about the type and size of the box.

Many files formatted according to the ISO base media file format start with a file type box, also referred to as FileTypeBox or the ftyp box. The ftyp box contains information of the brands labeling the file. The ftyp box includes one major brand indication and a list of compatible brands. The major brand identifies the most suitable file format specification to be used for parsing the file. The compatible brands indicate which file format specifications and/or conformance points to which the file conforms. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ftyp box. A file player may check if the ftyp box of a file comprises brands it supports, and may parse and play the file only if any file format specification supported by the file player is listed among the compatible brands.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames, or metadata frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleTableBox (also known as the sample table or the sample table box). The SampleTableBox contains the SampleDescriptionBox, which gives detailed information about the coding type used, and any initialization information needed for that coding. The SampleDescriptionBox contains an entry-count and as many sample entries as the entry-count indicates. The format of sample entries is track-type specific but derive from generic classes (e.g., VisualSampleEntry, AudioSampleEntry, Volumetric VisualSampleEntry). The type of sample entry form used for derivation the track-type specific sample entry format is determined by the media handler of the track.

A TrackTypeBox may be contained in a TrackBox. The payload of TrackTypeBox has the same syntax as the payload of FileTypeBox. The content of an instance of TrackTypeBox shall be such that it would apply as the content of FileTypeBox, if all other tracks of the file were removed and only the track containing this box remained in the file.

Movie fragments may be used, for example, when recording content to ISO files, for example, in order to avoid losing data if a recording application crashes, runs out of memory space, or some other incident occurs. Without movie fragments, data loss may occur because the file format may require that all metadata, for example, a movie box, be written in one contiguous area of the file. Furthermore, when recording a file, there may not be sufficient amount of memory space to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an mdat box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISOBMFF specification.

A self-contained movie fragment may be defined to consist of a moof box and an mdat box that are consecutive in the file order and where the mdat box contains the samples of the movie fragment (for which the moof box provides the metadata) and does not contain samples of any other movie fragment (i.e., any other moof box). A media segment may comprise one or more self-contained movie fragments. A media segment may be used for delivery, such as streaming, e.g., in MPEG-Dynamic Adaptive Streaming over Hypertext Transfer Protocol (HTTP) (MPEG-DASH).

The track reference mechanism can be used to associate tracks with each other. The TrackReferenceBox includes box(es), each of which provides a reference from the containing track to a set of other tracks. These references are labelled through the box type (i.e., the four-character code of the box) of the contained box(es). The ISO Base Media File Format contains three mechanisms for timed metadata that can be associated with particular samples: sample groups, timed metadata tracks, and sample auxiliary information. Derived specification may provide similar functionality with one or more of these three mechanisms.

TrackGroupBox, which is contained in TrackBox, enables indication of groups of tracks where each group shares a particular characteristic or the tracks within a group have a particular relationship. The box contains zero or more boxes, and the particular characteristic or the relationship is indicated by the box type of the contained boxes. The contained boxes include an identifier, which can be used to conclude the tracks belonging to the same track group. The tracks that contain the same type of a contained box within the TrackGroupBox and have the same identifier value within these contained boxes belong to the same track group. The syntax of the contained boxes may be defined through TrackGroupTypeBox is follows:

aligned(8) class TrackGroupTypeBox(unsigned int(32) track_group_type)
extends FullBox(track_group_type, version = 0, flags = 0)
{
unsigned int(32) track_group_id;
// the remaining data may be specified
//for a particular track_group_type
}

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the scalable video coding (SVC) file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used, e.g., to indicate a sub-type of the grouping.

Per-sample sample auxiliary information may be stored anywhere in the same file as the sample data itself; for self-contained media files, this is typically in a MediaDataBox or a box from a derived specification. The auxiliary information is stored either (a) in multiple chunks, with the number of samples per chunk, as well as the number of chunks, matching the chunking of the primary sample data or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is stored in the same file as the samples to which it relates as they share the same data reference (‘dref’) structure. However, this data may be located anywhere within this file, using auxiliary information offsets (‘saio’) to indicate the location of the data.

The restricted video (‘resv’) sample entry and mechanism has been specified for the ISOBMFF in order to handle situations where the file author requires certain actions on the player or renderer after decoding of a visual track. Players not recognizing or not capable of processing the required actions are stopped from decoding or rendering the restricted video tracks. The ‘resv’ sample entry mechanism applies to any type of video codec. A RestrictedSchemeInfoBox is present in the sample entry of ‘resv’ tracks and comprises an OriginalFormatBox, SchemeTypeBox, and SchemeInformationBox. The original sample entry type that would have been unless the ‘resv’ sample entry type were used is contained in the OriginalFormatBox. The SchemeTypeBox provides an indication which type of processing is required in the player to process the video. The SchemeInformationBox comprises further information of the required processing. The scheme type may impose requirements on the contents of the SchemeInformationBox. For example, the stereo video scheme indicated in the SchemeTypeBox indicates that when decoded frames either contain a representation of two spatially packed constituent frames that form a stereo pair (frame packing) or only one view of a stereo pair (left and right views in different tracks). Stereo VideoBox may be contained in SchemeInformationBox to provide further information, e.g., on which type of frame packing arrangement has been used (e.g., side-by-side or top-bottom).

Several types of stream access points (SAPs) have been specified, including the following. SAP Type 1 corresponds to what is known in some coding schemes as a “Closed group of pictures (GOP) random access point” (in which all pictures, in decoding order, can be correctly decoded, resulting in a continuous time sequence of correctly decoded pictures with no gaps) and in addition the first picture in decoding order is also the first picture in presentation order. SAP Type 2 corresponds to what is known in some coding schemes as a “Closed GOP random access point” (in which all pictures, in decoding order, can be correctly decoded, resulting in a continuous time sequence of correctly decoded pictures with no gaps), for which the first picture in decoding order may not be the first picture in presentation order. SAP Type 3 corresponds to what is known in some coding schemes as an “Open GOP random access point”, in which there may be some pictures in decoding order that cannot be correctly decoded and have presentation times less than intra-coded picture associated with the SAP.

A stream access point (SAP) sample group as specified in ISOBMFF identifies samples as being of the indicated SAP type.

A sync sample may be defined as a sample corresponding to SAP type 1 or 2. A sync sample can be regarded as a media sample that starts a new independent sequence of samples; if decoding starts at the sync sample, it and succeeding samples in decoding order can all be correctly decoded, and the resulting set of decoded samples forms the correct presentation of the media starting at the decoded sample that has the earliest composition time. Sync samples can be indicated with the SyncSampleBox (for those samples whose metadata is present in a TrackBox) or within sample flags indicated or inferred for track fragment runs.

Files conforming to the ISOBMFF may contain many non-timed objects, referred to as items, meta items, or metadata items, in a meta box (fourCC: ‘meta’), which may also be called a MetaBox. While the name of the meta box refers to metadata, items can generally contain metadata or media data. The meta box may reside at the top level of the file, within a movie box (fourCC: ‘moov’), and within a track box (fourCC: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. If the metadata is located external to the file then its location may be declared by the DataInformationBox (fourCC: ‘dinf’). In the specific case that the metadata is formatted using XML syntax and is required to be stored directly in the MetaBox, the metadata may be encapsulated into either the XMLBox (fourCC: ‘xml’) or the BinaryXMLBox (fourCC: ‘bxml’). An item may be stored as a contiguous byte range, or it may be stored in several extents, each being a contiguous byte range. In other words, items may be stored fragmented into extents, e.g., to enable interleaving. An extent is a contiguous subset of the bytes of the resource; the resource can be formed by concatenating the extents.

High Efficiency Image File Format (HEIF) is a standard developed by the Moving Picture Experts Group (MPEG) for storage of images and image sequences. Among other things, the standard facilitates file encapsulation of data coded according to High Efficiency Video Coding (HEVC) standard. HEIF includes features building on top of the used ISO Base Media File Format (ISOBMFF).

The ISOBMFF structures and features are used to a large extent in the design of HEIF. The basic design for HEIF comprises still images that are stored as items and image sequences that are stored as tracks.

In the context of HEIF, the following boxes may be contained within the root-level ‘meta’ box and may be used as described in the following. In HEIF, the handler value of the Handler box of the ‘meta’ box is ‘pict’. The resource (whether within the same file, or in an external file identified by a uniform resource identifier) containing the coded media data is resolved through the Data Information (‘dinf’) box, whereas the Item Location (‘iloc’) box stores the position and sizes of every item within the referenced file. The Item Reference (‘iref’) box documents relationships between items using typed referencing. If there is an item among a collection of items that is in some way to be considered the most important compared to others then this item is signaled by the Primary Item (‘pitm’) box. Apart from the boxes mentioned here, the ‘meta’ box is also flexible enough to include other boxes that may be necessary to describe items.

Any number of image items can be included in the same file. Given a collection image stored by using the ‘meta’ box approach, it sometimes is essential to qualify certain relationships between images. Examples of such relationships include indicating a cover image for a collection, providing thumbnail images for some or all of the images in the collection, and associating some or all of the images in a collection with auxiliary image such as an alpha plane. A cover image among the collection of images is indicated using the ‘pitm’ box. A thumbnail image or an auxiliary image is linked to the primary image item using an item reference of type ‘thmb’ or ‘auxl’, respectively.

The ItemPropertiesBox enables the association of any item with an ordered set of item properties. Item properties are small data records. The ItemPropertiesBox consists of two parts: ItemPropertyContainerBox that contains an implicitly indexed list of item properties, and one or more ItemPropertyAssociationBox(es) that associate items with item properties. Item property is formatted as a box.

A descriptive item property may be defined as an item property that describes rather than transforms the associated item. A transformative item property may be defined as an item property that transforms the reconstructed representation of the image item content.

An entity may be defined as a collective term of a track or an item. An entity group is a grouping of items, which may also group tracks. An entity group can be used instead of item references, when the grouped entities do not have clear dependency or directional reference relation. The entities in an entity group share a particular characteristic or have a particular relationship, as indicated by the grouping type.

An entity group is a grouping of items, which may also group tracks. The entities in an entity group share a particular characteristic or have a particular relationship, as indicated by the grouping type.

Entity groups are indicated in GroupsListBox. Entity groups specified in GroupsListBox of a file-level MetaBox refer to tracks or file-level items. Entity groups specified in GroupsListBox of a movie-level MetaBox refer to movie-level items. Entity groups specified in GroupsListBox of a track-level MetaBox refer to track-level items of that track.

GroupsListBox contains EntityToGroupBoxes, each specifying one entity group. The syntax of EntityToGroupBox may be specified as follows:

```
aligned(8) class EntityToGroupBox(grouping_type, version, flags)
extends
FullBox(grouping_type, version, flags) {
  unsigned int(32) group_id;
  unsigned int(32) num_entities_in_group;
  for(i=0; i<num_entities_in_group; i++)
    unsigned int(32) entity_id;
  // the remaining data may be specified
  // for a particular grouping_type
}
```

In this example, entity_id is resolved to an item, when an item with item_ID equal to entity_id is present in the hierarchy level (file, movie or track) that contains the GroupsListBox, or to a track, when a track with track_ID equal to entity_id is present and the GroupsListBox is contained in the file level.

Now that the overview of the technical area has been presented, a discussion of problems is provided. One of the issues in this technology area is that, in order to store and distribute V-DMC encoded content as files to end users and other intermediary systems (e.g., DASH), a storage mechanism for V-DMC bitstream in ISOBMFF needs to be defined. V-DMC introduces a new component called a base-mesh component, which does not have any definition on how this component should be stored in ISOBMFF. Thus, in today's systems, it is impossible to store V-DMC compressed bitstreams in ISOBMFF.

The following examples address this and other issues. An example of a method is described in FIG. 3, which is a logic flow diagram for base-mesh storage and transmission in ISOBMFF. In block 302, an apparatus executing an encoder, and performing at least an encapsulation process as part of the encoding, accesses a V-DMC coded bitstream, wherein the V-DMC coded bitstream comprises an attribute information bitstream, a geometry information bitstream, an atlas bitstream, and a base-mesh bitstream. The encoder (e.g., as executed by the apparatus) stores, in block 304 for later transmission, the V-DMC coded bitstream in a file structure compliant with an international organization for standardization base media file format (ISOBMFF). Another action that can occur, e.g., after the storing (either immediately, such as in short-term memory, or after a time period of minutes or days or the like), is illustrated also by block 304, where the apparatus transmits the V-DMC coded bitstream in the file structure compliant with an international organization for standardization base media file format (ISOBMFF).

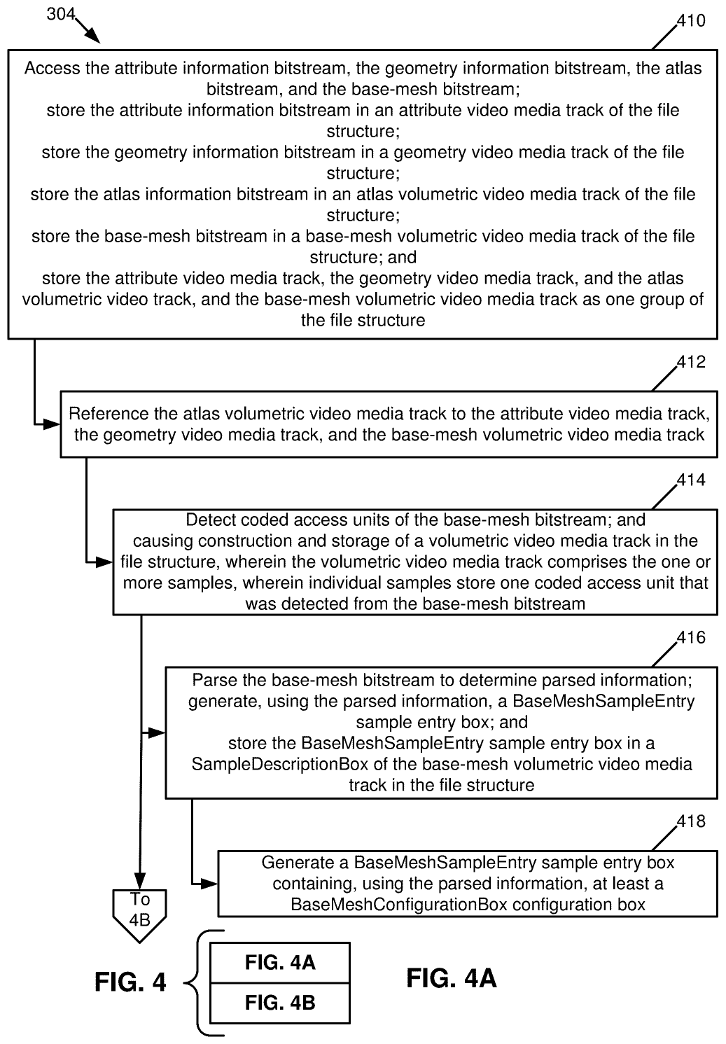

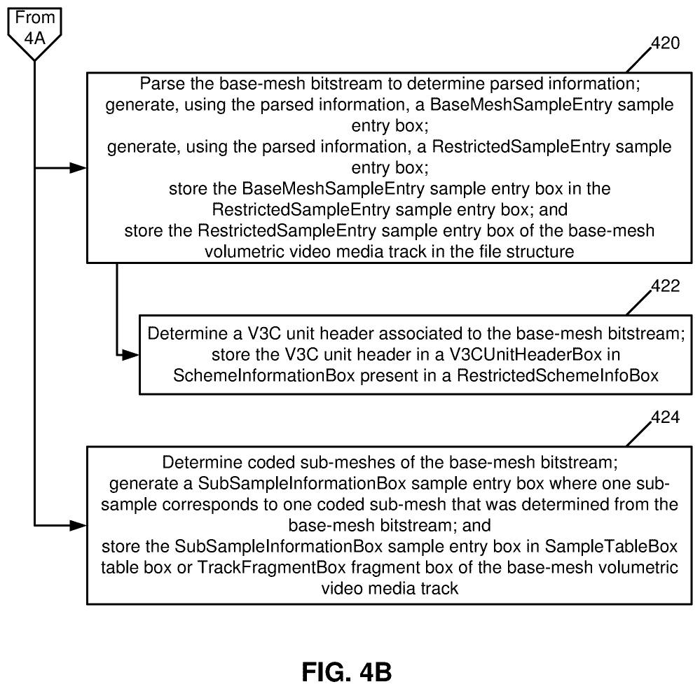

The storing that occurs in block 304 has multiple options that are described in FIGS. 4 (split over FIGS. 4A and 4B), 5 and 6. These are further described below.

Referring to FIG. 4, split over FIGS. 4A and 4B, this figure is a logic flow diagram for storing a V-DMC coded bitstream in a file structure compliant with an international organization for standardization base media file format (ISOBMFF). FIG. 4 is a further example of block 304 of FIG. 3. In block 410, the storing comprises the following:
accessing the attribute information bitstream, the geometry information bitstream, the atlas bitstream, and the base-mesh bitstream;
storing the attribute information bitstream in an attribute video media track of the file structure;
storing the geometry information bitstream in a geometry video media track of the file structure;
storing the atlas information bitstream in an atlas volumetric video media track of the file structure;
storing the base-mesh bitstream in a base-mesh volumetric video media track of the file structure; and

storing the attribute video media track, the geometry video media track, and the atlas volumetric video track, and the base-mesh volumetric video media track as one group of the file structure.

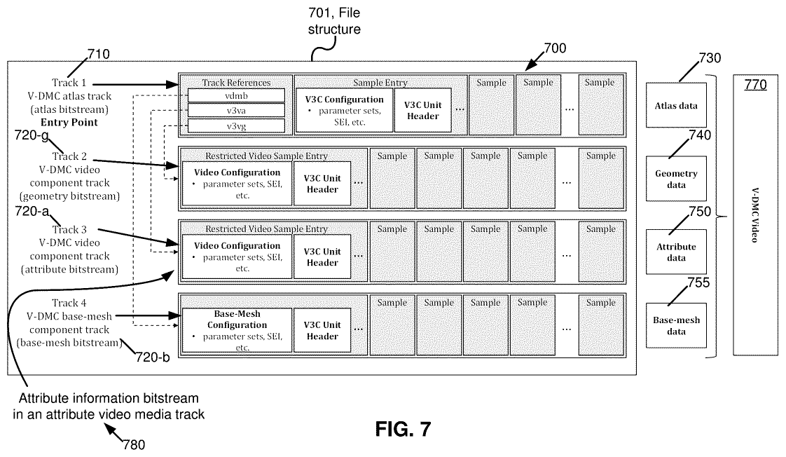

Block 410 is illustrated in part in an example by FIG. 7. Encapsulation of a V-DMC bit stream in ISOBMFF is defined in ISO/IEC 23090-10. This example adds the base-mesh bitstream, as part of a V-DMC base-mesh component track 720-b, to the data container 700. The container 700 is part of an ISOBMFF file structure 701, which, as is known, would have many “layers” of boxes and data. For an overview, see Lauri Ilola, Lukasz Kondrad, Sebastian Schwarz, and Ahmed Hamza, “An Overview of the MPEG Standard for Storage and Transport of Visual Volumetric Video-Based Coding”, Front. Sig. Proc. 2:883943, doi: 10.3389/frsip.2022.883943 (2022).

Encapsulation of a bitstream into a file may be defined as including or enclosing the bitstream into the file possibly with metadata that may, for example, assist in random accessing the bitstream. When encapsulating in ISOBMFF (as defined in ISO/IEC 23090-10) using the techniques outlined herein, a V-DMC elementary bitstream with dynamic data is split into one V-DMC atlas track and number of V-DMC video component tracks, and V-DMC base-mesh component tracks. A V-DMC atlas track 710 (see FIG. 7) contains a V-DMC parameter set, and atlas data information. V-DMC video component tracks contain video encoded information (geometry 720-g, attribute 720-a) . . . . V-DMC base-mesh component tracks contain base-mesh encoded information 720-b. There are multiple ways to examine this figure. One is that the data container 700 is parsed and formed into constituent components that are formed into a video. In this example, the outputs are atlas data 730, geometry data 740, attribute data 750, and base-mesh data 755, which are used to form the V-DMC video 770 that is output. Another way to look at FIG. 7 is that the V-DMC video 770 is an input that is parsed to create the atlas data 730, geometry data 740, attribute data 750, and base-mesh data 755, and these data are used to form the data container 700.

V-DMC atlas track is linked to V-DMC video component tracks using a track reference mechanism of ISOBMFF, see FIG. 7, which is a block diagram of an overview of data container 700, for encapsulating timed V-DMC data (e.g., for video) with a single atlas with a single atlas tile. The data container 700 may be thought of as describing relations in an ISO base media file format. The boxes in the figure map to corresponding ISOBMFF boxes, as defined, e.g., in ISO/IEC 14496-12 and the derived specification and boxes presented in the techniques herein.

Some of the track reference type(s) used are described below.
1) ‘vdmb’: the referenced track(s) contain the video-coded base-mesh V3C component. The 4CC of vdmb is just one example of a 4CC that can be used, any other 4CC indicator can be used instead for this track reference type.
2) ‘v3va’: the referenced track(s) contain the video-coded attribute V3C component.
3) ‘v3vg’: the referenced track(s) contain the video-coded geometry V3C component.

Reference 780 shows one example where an attribute information bitstream from the V-DMC coded bitstream is stored in an attribute video media track that is part of the attribute bitstream of track 3, 720-a. This is one example of how attribute information bitstream from the V-DMC coded bitstream may be stored in the ISOBMFF data container 700 of FIG. 7.

In block 412 of FIG. 4A, the storing further comprises referencing the atlas volumetric video media track to the attribute video media track, the geometry video media track, and the base-mesh volumetric video media track. One way to perform this referencing is by using a track reference mechanism to associate tracks with each other, such as using a TrackReferenceBox as previously described. That is, to link a V3C atlas track with V-DMC base-mesh track(s), the track reference tool of ISO/IEC 14496-12 can be used. The 4CCs of these track reference types can be ‘vdmb’, although any other 4CC may also be used.

In block 414, which as an example of block 412, the storing further comprises the following:
detecting coded access units of the base-mesh bitstream; and
causing construction and storage of a volumetric video media track in the file structure, wherein the volumetric video media track comprises the one or more samples, wherein individual samples store one coded access unit that was detected from the base-mesh bitstream.

In further detail, a base-mesh sample format may be described having the following definition: Each sample in a V-DMC base-mesh track corresponds to a single coded base-mesh access unit.

The syntax could be the following:

```
aligned(8) class BaseMeshSample {
  // sample_size value is the size of the sample from the SampleSizeBox
  for (int i=0; i < sample_size; ) {
    sample_stream_nal_unit ss_nal_unit; // as defined in ISO/IEC
      // FDIS 23090-5, ss_nal_unit containing nal unit of
      // base-mesh as defined in Annex H of 23090-29
    i += ss_nal_unit.ssnu_nal_unit_size +
    V3CDecoderConfigurationRecord.unit_size_precision_bytes_minus1 + 1
  }
}
```

The semantics could be as follows.

ss_nal_unit contains a single BMCL or non-BMCL NAL unit as defined in 23090-29: Annex H in NAL unit sample stream format as defined in ISO/IEC 23090-5: Annex D.

ssnu_nal_unit_size specifies the size, in bytes, of the sample stream NAL unit. The number of bits used to represent ssnu_nal_unit_size is equal to (BaseMeshDecoderConfigurationRecord.unit_size_precision_bytes_minus1+1)*8.

A base-mesh track sync sample could be as follows. A sync sample in a base-mesh track is a sample that contains an intra random access point (IRAP) coded base-mesh access unit as defined in ISO/IEC 23090-29.

A coded base-mesh access unit may be as follows. For example, the following could specify coded base-mesh access unit:
1) An access unit includes one coded base-mesh frame with nuh_layer_id equal to 0, zero or more BMCL NAL units with nuh_layer_id greater than 0 (zero) and zero or more non-BMCL NAL units.
2) Let firstBMFNalUnit be the first BMCL NAL unit of a coded base-mesh frame with nuh_layer_id equal to 0 (zero). The first of any of the following NAL units preceding firstBMFNalUnit and succeeding the last BMCL NAL unit preceding firstBMFNalUnit, if any, specifies the start of a new access unit:
a) access unit delimiter NAL unit with nuh_layer_id equal to 0 (zero) (when present),
b) base-mesh sequence parameter set (BSMPS) NAL unit with nuh_layer_id equal to 0 (when present),
c) base-mesh frame parameter set (BMFPS) NAL unit with nuh_layer_id equal to 0 (when present),
c) prefix supplemental enhancement information (SEI) NAL unit with nuh_layer_id equal to 0 (when present),
d) NAL units with nal_unit_type in the range of NAL_RSV_NBMCL_40 . . . . NAL_RSV_NBMCL_44 (which represent reserved NAL units) with nuh_layer_id equal to 0 (when present),
f) NAL units with nal_unit_type in the range of UNSPEC45 . . . . UNSPEC63 (which represent unspecified NAL units) with nuh_layer_id equal to 0 (zero) (when present).
3) The first NAL unit preceding firstBMFNalUnit and succeeding the last BMCL NAL unit preceding firstBMFNalUnit, if any, can only be one of the above-listed NAL units.
4) When there is none of the above NAL units preceding firstBMFNalUnit and succeeding the last BMCL NAL preceding firstBMFNalUnit, if any, firstBMFNalUnit starts a new access unit.

Block 416 is an example of block 414. In block 416, the storing further comprises:
parsing the base-mesh bitstream to determine parsed information;
generating, using the parsed information, a BaseMeshSampleEntry sample entry box; and
storing the BaseMeshSampleEntry sample entry box in a SampleDescriptionBox of the base-mesh volumetric video media track in the file structure.

As is known in this technical area, the base-mesh bitstream is parsed in order to get information (referred to as parsed information) about the bitstream, and then other operations such as creating sample entry box and including the needed information in this box may be performed, using the parsed information.

A base-mesh sample entry may be used for block 416. A definition of the same could be the following.
Sample Entry Type: ‘dbm1’, ‘dbmg’.
Container: SampleDescriptionBox.
Mandatory: A ‘dmb1’, or ‘dbmg’ sample entry is mandatory.
Quantity: One or more.
Base-mesh tracks may use BaseMeshSampleEntry, which extends Volumetric VisualSampleEntry with a sample entry type of ‘dbm1’, or ‘dbmg’. The following restrictions may be set for base-mesh tracks:
1) A base-mesh track shall not carry BMCL NAL units belonging to more than one atlas.
2) A base-mesh track sample entry contains a BaseMeshConfigurationBox and V3CUnitHeaderBox.

The syntax may be the following:

```
aligned(8) class BaseMeshSampleEntry( ) extends
VolumetricVisualSampleEntry (type) {
  BaseMeshConfigurationBox config;
  V3CUnitHeaderBox unit_header; // optional
  MPEG4ExtensionDescriptorsBox descr; // optional
}
class MPEG4ExtensionDescriptorsBox extends Box(‘m4ds’) {
  Descriptor Descr[0 .. 255];
}
```

The semantics could include the following.
compressorname in the base class Volumetric VisualSampleEntry indicates the name of the compressor used with the value “\012V3C Coding” being recommended; the first byte is a count of the remaining bytes, here represented by \012, which (being octal 12) is 10 (decimal), the number of bytes in the rest of the string.

Descr is a descriptor that should be placed in the ElementaryStreamDescriptor when this stream is used in an MPEG-4 systems context. This does not include SLConfigDescriptor or DecoderConfigDescriptor, but includes the other descriptors in order to be placed after the SLConfigDescriptor.

For block 416, which is a further example of block 414, the storing further comprises: generating a BaseMeshSampleEntry sample entry box containing at least a BaseMeshConfigurationBox configuration box.

Further possible details for block 416 include the following. A suitable definition is the following: A Base-mesh decoder configuration box includes a BaseMeshDecoderConfigurationRecord.

Syntax of this includes the following.

```
class BaseMeshConfigurationBox extends FullBox(‘dbmC’,
version = 0, 0) {
  BaseMeshDecoderConfigurationRecord( );
}
aligned(8) class BaseMeshDecoderConfigurationRecord {
  unsigned int(3) unit_size_precision_bytes_minus1;
  // any fields related to profiles of the base-mesh bitstream
  bit (5) reserved = 0;
  unsigned int(8) num_of_setup_unit_arrays;
  for (int j=0; j < num_of_setup_unit_arrays; j++) {
    unsigned int(1) array_completeness;
    bit(1) reserved = 0;
    unsigned int(6) nal_unit_type;
    unsigned int(8) num_nal_units;
    for (int i=0; i < num_nal_units; i++) {
      unsigned int(16) setup_unit_length;
      // nal_unit(size) as defined in ISO/IEC FDIS 23090-29:Annex H
      nal_unit setup_unit(setup_unit_length);
    }
  }
}
```

The semantics may include the following.

unit_size_precision_bytes_minus1 plus 1 specifies the precision, in bytes, of the sample stream NAL unit to which this configuration record applies.

num_of_setup_unit_arrays indicates the number of arrays of base-mesh NAL units of the indicated type(s).

array_completeness when equal to 1 (one) indicates that all atlas NAL units of the given type are in the following array and none are in the stream; when equal to 0 (zero) indicates that additional base-mesh NAL units of the indicated type may be in the stream; the default and permitted values are constrained by the sample entry name.

nal_unit_type indicates the type of the atlas NAL units in the following array (which shall be all of that type); it takes a value as defined in ISO/IEC 23090-29 Annex H.

num_nal_units indicates the number of atlas NAL units of type nal_unit_type included in the configuration record for the stream to which this configuration record applies.

setup_unit_length indicates the size, in bytes, of the setup_unit field. The length field includes the size of both the NAL unit header and the NAL unit payload but does not include the length field itself.

setup_unit contains a NAL unit according to related nal_unit_type.

In block 420, which depends from block 414, the storing further comprises:
parsing the base-mesh bitstream to determine parsed information;
generating, using the parsed information, a BaseMeshSampleEntry sample entry box;
generating, using the parsed information, a RestrictedSampleEntry sample entry box;
storing the BaseMeshSampleEntry sample entry box in the RestrictedSampleEntry sample entry box; and
storing the RestrictedSampleEntry sample entry box of the base-mesh volumetric video media track in the file structure.

In block 422, which depends from block 420, the storing further comprises:
determining a V3C unit header associated to the base-mesh bitstream; and
storing the V3C unit header in a V3CUnitHeaderBox in SchemeInformationBox present in RestrictedSchemeInfoBox.

For blocks 420 and 422, a V3C base-mesh component track may be represented in the file as restricted volumetric video and may use a generic restricted sample entry ‘resv’ with additional requirements:
1) SchemeTypeBox is present in RestrictedSchemeInfoBox and scheme_type is set to ‘vvvc’;
2) SchemeInformationBox is present in RestrictedSchemeInfoBox and can contain a V3CUnitHeaderBox; and
3) In track header the track_in_movie flag is set to 0 (zero), to indicate that this track should not be presented alone.

Block 424 also depends from block 414, and in this block, the storing further comprises:
parsing the base-mesh bitstream,
determining coded sub-meshes of the base-mesh bitstream;
generating a SubSampleInformationBox sample entry box where one sub-sample corresponds to one coded sub-mesh that was determined from the base-mesh bitstream; and
storing the SubSampleInformationBox sample entry box in Sample TableBox table box or TrackFragmentBox fragment box of the base-mesh volumetric video media track.

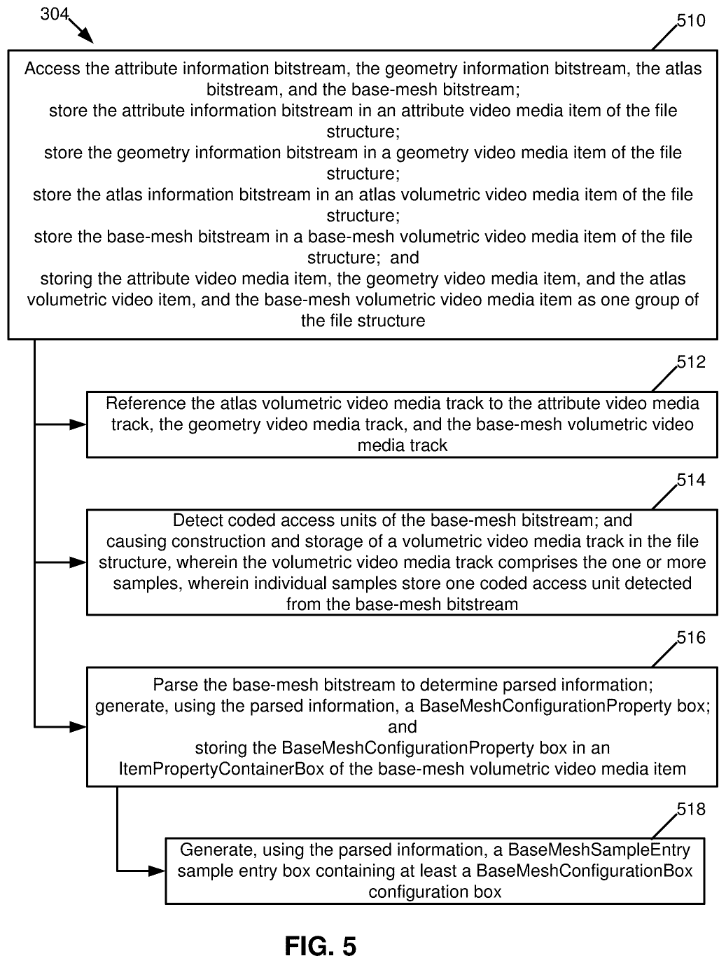

Turning to FIG. 5, this figure is a further example of a logic flow diagram for storing a V-DMC coded bitstream in a file structure compliant with an international organization for standardization base media file format (ISOBMFF). FIG. 5 is a further example of block 304 of FIG. 3.

In block 510, the storing further comprises:
accessing the attribute information bitstream, the geometry information bitstream, the atlas bitstream, and the base-mesh bitstream;
storing the attribute information bitstream in an attribute video media item of the file structure;
storing the geometry information bitstream in a geometry video media item of the file structure;
storing the atlas information bitstream in an atlas volumetric video media item of the file structure;
storing the base-mesh bitstream in a base-mesh volumetric video media item of the file structure; and
storing the attribute video media item, the geometry video media item, and the atlas volumetric video item, and the base-mesh volumetric video media item as one group of the file structure.

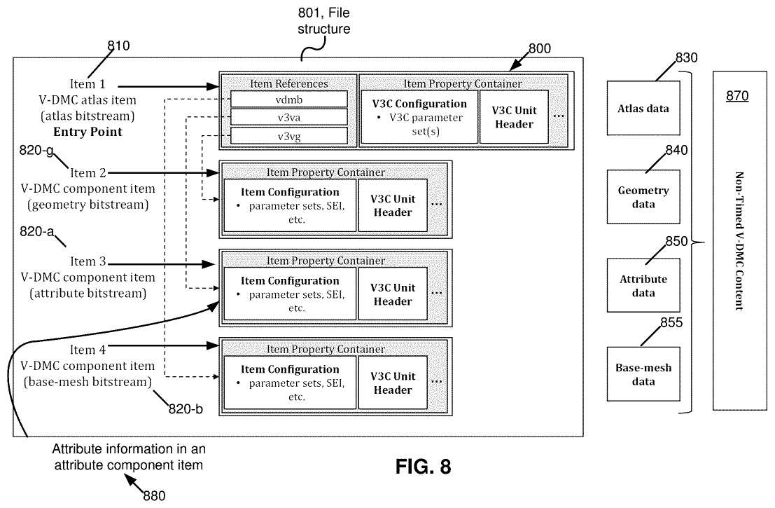

Blocks 512 to 516 depend from block 510. In block 512, the storing further comprises: referencing the atlas volumetric video media item to the attribute video media item, the geometry video media item, and the base-mesh volumetric video media item. With respect to block 512, FIG. 8 is illustrated in an example. Encapsulation of a V-DMC bit stream in ISOBMFF is defined in ISO/IEC 23090-10. Encapsulation of a bitstream into a file may be defined as including or enclosing the bitstream into the file possibly with metadata that may, for example, assist in random accessing the bitstream. For this example of encapsulation, a V-DMC atlas item is linked to V-DMC video component items using an item reference mechanism of ISOBMFF, see FIG. 8, which is a block diagram of an overview of data container 800 for encapsulating non-timed V-DMC data with a single atlas with a single atlas tile. The data container 800 may be thought of as describing relations in an ISO base media file format. The container 800 is part of an ISOBMFF file structure 801, which, as is known, would have many “layers” of boxes and data. For an overview, see Lauri Ilola, Lukasz Kondrad, Sebastian Schwarz, and Ahmed Hamza, “An Overview of the MPEG Standard for Storage and Transport of Visual Volumetric Video-Based Coding”, Front. Sig. Proc. 2:883943, doi: 10.3389/frsip.2022.883943 (2022). When encapsulating in ISOBMFF (ISO/IEC 23090-10), a V-DMC elementary bitstream with dynamic data is split into one V-DMC atlas item and number of V-DMC video component items. Similar to FIG. 7, a base-mesh bitstream is added, in this example as Item 4 820-b, and this is referenced by the 4CC of vdmb, which is merely one example of a 4CC that may be used. The attribute information may be stored in an attribute component item as part of the attribute bitstream of Item 3 820-a.

A V-DMC atlas item 810 (see FIG. 8) contains a V-DMC parameter set, and atlas data information. V-DMC video component items contain video encoded information (geometry 820-g, attribute 820-a). V-DMC base-mesh component items contain base-mesh encoded information 820-b As with FIG. 7, FIG. 8 may be construed so that the data container 800 is parsed and formed into constituent components that are formed into a static 3D object or similar non-timed content. In this example, the outputs are atlas data 830, geometry data 840, attribute data 850, and base-mesh data 855, which are used to form the non-timed V-DMC content 870 that is output. Another way to look at FIG. 8 is that the non-timed V-DMC content 870 is an input that is parsed to create the atlas data 830, geometry data 840, attribute data 850, and base-mesh data 855, and these data are used to form the data container 800.

Reference 880 shows one example where an attribute information bitstream from the V-DMC coded bitstream is stored in an attribute component item that is part of the attribute bitstream of track 3, 820-a. This is one example of how attribute information bitstream from the V-DMC coded bitstream may be stored in the ISOBMFF data container 800 of FIG. 8.

In block 514, the storing further comprises:
detecting coded access units of base-mesh bitstream; and
causing construction and storage of a volumetric video media item in the file structure, wherein the volumetric video media item comprises one coded access unit of the base-mesh bitstream.

In block 516, the storing further comprises:
parsing base-mesh bitstream to determine parsed information;
generating, using the parsed information, a BaseMeshConfigurationProperty box; and
storing the BaseMeshConfigurationProperty box in an ItemPropertyContainerBox of the base-mesh volumetric video media item.

In further detail, a definition for this could include the following:
Box Types: ‘dbmC’
Property type: Descriptive item property
Container: ItemPropertyContainerBox
Mandatory (per item): Yes, for a base-mesh item
Quantity (per item): One for a Base-mesh item
BaseMeshConfigurationProperty is stored as descriptive item property and shall be associated with base-mesh items.

The base-mesh configuration item property is an essential property. The corresponding essential flag in the ItemProperyAssociationBox should be set to 1 (one) for a ‘dbmC’ item property.

The syntax may be the following:

```
aligned(8) class BaseMeshConfigurationProperty
  extends ItemFullProperty(‘v3cC’,version=0, flags) {
  BaseMeshDecoderConfigurationRecord decoder_config(version);
}
```

Block 518 depends from block 516. In block 518, the storing further comprises:
generating a BaseMeshConfigurationProperty box containing at least a BaseMeshDecoderConfigurationRecord configuration box.

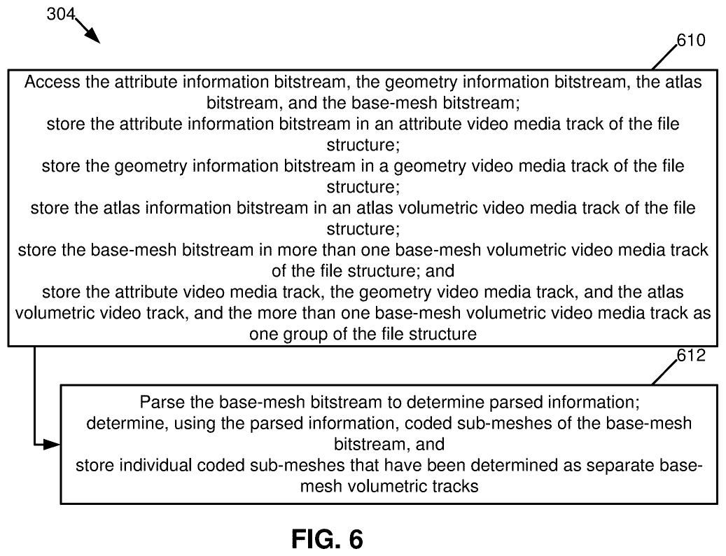

Referring to FIG. 6, FIG. 6 is a further example of a logic flow diagram for storing a V-DMC coded bitstream in a file structure compliant with an international organization for standardization base media file format (ISOBMFF). FIG. 6 is a further example of block 304 of FIG. 3.

In block 610, the storing further comprises:
accessing the attribute information bitstream, the geometry information bitstream, the atlas bitstream, and the base-mesh bitstream;
storing the attribute information bitstream in an attribute video media track of the file structure;
storing the geometry information bitstream in a geometry video media track of the file structure;
storing the atlas information bitstream in an atlas volumetric video media track of the file structure;
storing the base-mesh bitstream in more than one base-mesh volumetric video media track of the file structure; and
storing the attribute video media track, the geometry video media track, and the atlas volumetric video track, and the more than one base-mesh volumetric video media track as one group of the file structure.

Block 612 depends from block 610, and in block 612, the storing further comprises the following:
parsing the base-mesh bitstream to determine parsed information;
determining, using the parsed information, coded sub-meshes of the base-mesh bitstream, and
storing individual coded sub-meshes that have been determined as separate base-mesh volumetric tracks.

As a further example, a V3CDecoderConfigurationRecord in the atlas track or in the atlas item may be used to store base-mesh related parameter sets.

As yet another example, a number of syntax elements of syntax structures parameter sets of a base-mesh sub-bitstream may be extracted and stored as variables of the BaseMeshConfigurationRecord. For example, variables related to profiles information of the base-mesh subitstream, as in the following example:

```
aligned(8) class BaseMeshDecoderConfigurationRecord {
  unsigned int(3) unit_size_precision_bytes_minus1;
  // any fields related to profiles of the base-mesh bitstream
  bit (5) reserved = 0;
  unsigned int(2) general_profile_space;
  unsigned int(1) general_tier_flag;
  unsigned int(5) general_profile_idc;
  unsigned int(32) general_profile_compatibility_flags;
  unsigned int(48) general_constraint_indicator_flags;
  unsigned int(8) general_level_idc;
  unsigned int(8) num_of_setup_unit_arrays;
  for (int j=0; j < num_of_setup_unit_arrays; j++) {
    unsigned int(1) array_completeness;
    bit(1) reserved = 0;
    unsigned int(6) nal_unit_type;
    unsigned int(8) num_nal_units;
    for (int i=0; i < num_nal_units; i++) {
      unsigned int(16) setup_unit_length;
      // nal_unit(size) as defined in ISO/IEC FDIS 23090-29:Annex H
      nal_unit setup_unit(setup_unit_length);
    }
  }
}
```

Referring to FIG. 9, this figure is a logic flow diagram for base-mesh decoding in ISOBMFF. An apparatus that performs decoding is the entity performing the operations in the blocks. In block 902, the apparatus receives (or accesses) a V-DMC coded bitstream stored in a file structure compliant with an international organization for standardization base media file format (ISOBMFF). In block 904, the apparatus parses the received ISOBMFF file structure to extract the V-DMC coded bitstream that comprises an attribute information bitstream, a geometry information bitstream, an atlas bitstream, and a base-mesh bitstream. The parsing, see block 906, performs extraction based on blocks in FIGS. 4, 5, and 6 so that the boxes, references, and other information are the starting point and operations in these blocks are reversed to end up with the base-mesh bitstream. For instance, consider block 416 of FIG. 4A. The parsing in block 906 would find the SampleDescriptionBox of the base-mesh volumetric video media track in the file structure, and from the SampleDescriptionBox parse out the BaseMeshSampleEntry sample entry box stored in the SampleDescriptionBox. Information stored in the BaseMeshSampleEntry sample entry box can then form part of the V-DMC coded bitstream.

In block 908, the apparatus performs decoding with at least the base-mesh bitstream to recreate media. The media could be the V-DMC video 770 (or other timed media) or the non-timed V-DMC content 870, as examples. In block 910, the apparatus stores or outputs for display the recreated media.

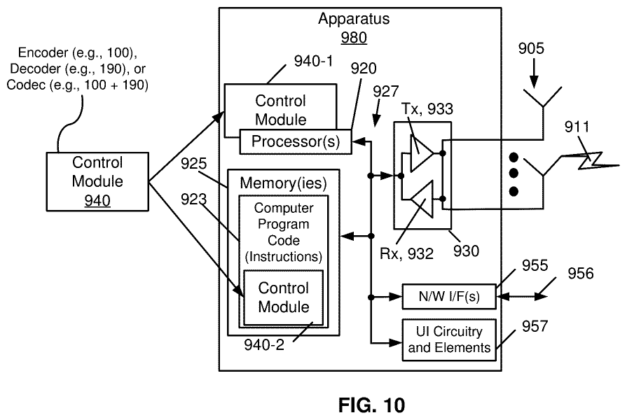

Turning to FIG. 10, this figure is an example of a block diagram of an apparatus suitable for implementing any of the encoders or decoders described herein. The apparatus 980 includes circuitry comprising one or more processors 920, one or more memories 925, one or more transceivers 930, one or more network (N/W) interface(s) (I/F(s)) 955 and user interface (UI) circuitry and elements 957, interconnected through one or more buses 927. Depending on implementation, some apparatus may not have all of the circuitry. For example, an apparatus 980 might not have UI circuitry and elements 957. An apparatus may have additional circuitry, not described here. FIG. 10 is presented merely as an example.

Each of the one or more transceivers 930 includes a receiver, Rx, 932 and a transmitter, Tx, 933. The one or more buses 927 may be address, data, and/or control buses, and may include any interconnection mechanism, such as a series of lines on a motherboard or integrated circuit, fiber optics or other optical communication equipment, and the like. The one or more transceivers 930 are connected to one or more antennas 905, and may communicate using wireless link 911.

The one or more memories 925 include computer program code 923. The apparatus 980 includes a control module 940, comprising one of or both parts 940-1 and/or 940-2. The control module 940 may implement an encoder (such as encoder 100), a decoder (such as decoder 190), or a codec (e.g., 100+190), which implements both encoding and decoding. The control module itself may be implemented in a number of ways. The control module 940 may be implemented in hardware as control module 940-1, such as being implemented as part of the one or more processors 920. The control module 940-1 may be implemented also as an integrated circuit or through other hardware such as a programmable gate array. In another example, the control module 940 may be implemented as control module 940-2, which is implemented as computer program code (having corresponding instructions) 923 and is executed by the one or more processors 920. For instance, the one or more memories 925 store instructions that, when executed by the one or more processors 920, cause the apparatus 980 to perform one or more of the operations as described herein. Furthermore, the one or more processors 920, one or more memories 925, and example algorithms (e.g., as flowcharts and/or signaling diagrams), encoded as instructions, programs, or code, are means for causing performance of the operations described herein.

The network interface(s) (N/W I/F(s)) 955 are wired interfaces communicating using link(s) 956, which could be fiber optic or other wired interfaces. The apparatus 980 could include only wireless transceiver(s) 930, only N/W I/Fs 955, or both wireless transceiver(s) 930 and N/W I/Fs 955.

The apparatus 980 may or may not include UI circuitry and elements 957. These could include a display such as a touchscreen, speakers, or interface elements such as for headsets. For instance, an apparatus 980 of a smartphone would typically include at least a touchscreen and speakers. The UI circuitry and elements 957 may also include circuitry to communicate with external UI elements (not shown) such as displays, keyboards, mice, headsets, and the like.

The computer readable memories 925 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 925 may be means for performing storage functions. The processors 920 may be of any type suitable to the local technical environment, and may include one or more of general-purpose computers, special purpose computers, microprocessors, digital signal processors (DSPs) and processors based on a multi-core processor architecture, as non-limiting examples. The processors 920 may be means for performing functions, such as controlling the apparatus 980, and other functions as described herein.

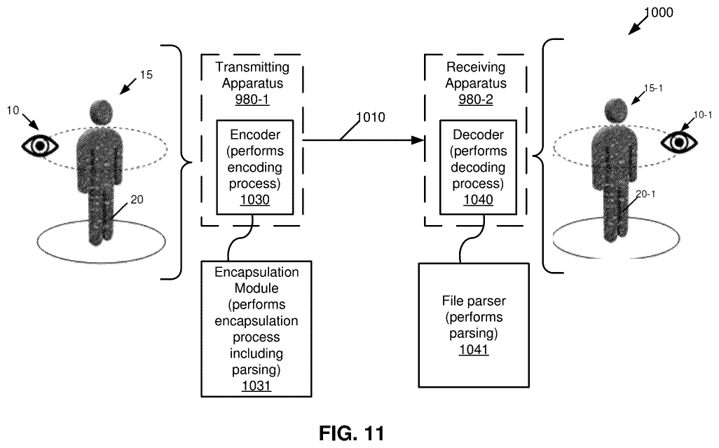

Turning to FIG. 11, FIG. 11 is a block diagram illustrating a system 1000 in accordance with an example. In the example, the encoder 1030 is used to encode video from the scene 15, and the encoder 1030 is implemented in a transmitting apparatus 980-1. The encoder 1030 uses the encapsulation module 1031, which forms any of the files structures in FIG. 7 or 8 and performs an encapsulation process, including parsing, or any other elements described herein to encapsulate data, and which forms part of the bitstream 1010 signaled by the encoder 1030. The encoder 1030 produces a bitstream 1010 that is received by the receiving apparatus 980-2, which implements a decoder 1040. The decoder 1130 uses the file parser 1041, which performs parsing to parse the file structures such as in FIG. 7 or 8 that have been received. The decoder 1130 forms the video for the scene 15-1, and the receiving apparatus 980-2 would present this to the user, e.g., via a smartphone, television, or projector among many other options. In this example, there is a capture of 3D media from the volumetric capture at a viewpoint 10 of a scene 15, which includes a human being 20. The receiving apparatus 980-2 reproduces a version of the 3D media at a viewpoint 10-1 of a scene 15-1, which includes a human being 20-1. It is noted that the encapsulation module 1031 can be split from the encoder 1030, and the file parser 1041 can be split from the decoder 1040 if desired.

Without in any way limiting the scope, interpretation, or application of the claims appearing below, a technical effect and/or advantage of one or more of the example embodiments disclosed herein is definition of the storage of base mesh and consequently enable storage of V-DMC.

The following are additional examples.

Example 1. A method comprising: accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

Example 2. The method according to example 1, wherein the storing comprises: accessing the attribute information bitstream, the geometry information bitstream, the atlas bitstream, and the base-mesh bitstream; storing the attribute information bitstream in an attribute video media track of the file structure; storing the geometry information bitstream in a geometry video media track of the file structure; storing the atlas information bitstream in an atlas volumetric video media track of the file structure; storing the base-mesh bitstream in a base-mesh volumetric video media track of the file structure; and storing the attribute video media track, the geometry video media track, and the atlas volumetric video track, and the base-mesh volumetric video media track as one or more groups of the file structure.

Example 3. The method according to example 2, wherein the storing further comprises: referencing, using corresponding track references, the atlas volumetric video media track to the attribute video media track, the geometry video media track, and the base-mesh volumetric video media track.

Example 4. The method according to example 2, wherein the storing further comprises: detecting coded access units of the base-mesh bitstream; and causing construction and storage of a volumetric video media track in the file structure, wherein the volumetric video media track comprises the one or more samples, wherein individual samples store one coded access unit that was detected from the base-mesh bitstream.

Example 5. The method according to example 4, wherein the storing further comprises: parsing the base-mesh bitstream to determine parsed information; generating, using the parsed information, a BaseMeshSampleEntry sample entry box; and storing the BaseMeshSampleEntry sample entry box in a SampleDescriptionBox of the base-mesh volumetric video media track in the file structure.

Example 6. The method according to example 5, wherein the storing further comprises: generating. using the parsed information, a BaseMeshSampleEntry sample entry box containing at least a BaseMeshConfigurationBox configuration box.

Example 7. The method according to example 4, wherein the storing further comprises: parsing the base-mesh bitstream to determine parsed information; generating, using the parsed information, a BaseMeshSampleEntry sample entry box; generating, using the parsed information, a RestrictedSampleEntry sample entry box; storing the BaseMeshSampleEntry sample entry box in the RestrictedSampleEntry sample entry box; and storing the RestrictedSampleEntry sample entry box of the base-mesh volumetric video media track in the file structure.

Example 8. The method according to example 7, wherein the storing further comprises: determining a V3C unit header associated to the base-mesh bitstream; and storing the V3C unit header in a V3CUnitHeaderBox in SchemeInformationBox present in a RestrictedSchemeInfoBox.

Example 9. The method according to example 4, wherein the storing further comprises: parsing the base-mesh bitstream to determine parsed information; determining coded sub-meshes of the base-mesh bitstream; generating a SubSampleInformationBox sample entry box where one sub-sample corresponds to one coded sub-mesh that was determined from the base-mesh bitstream; and storing the SubSampleInformationBox sample entry box in SampleTableBox table box or TrackFragmentBox fragment box of the base-mesh volumetric video media track.

Example 10. The method according to example 1, wherein the storing further comprises: accessing the attribute information bitstream, the geometry information bitstream, the atlas bitstream, and the base-mesh bitstream; storing the attribute information bitstream in an attribute video media item of the file structure; storing the geometry information bitstream in a geometry video media item of the file structure; storing the atlas information bitstream in an atlas volumetric video media item of the file structure; storing the base-mesh bitstream in a base-mesh volumetric video media item of the file structure; and storing the attribute video media item, the geometry video media item, and the atlas volumetric video item, and the base-mesh volumetric video media item as one or more groups of the file structure.

Example 11. The method according to example 10, wherein the storing further comprises: referencing, using corresponding track references, the atlas volumetric video media item to the attribute video media item, the geometry video media item, and the base-mesh volumetric video media item.

Example 12. The method according to example 10, wherein the storing further comprises: detecting coded access units of base-mesh bitstream; and causing construction and storage of a volumetric video media item in the file structure, wherein the volumetric video media item comprises one coded access unit of the base-mesh bitstream.

Example 13. The method according to example 10, wherein the storing further comprises: parsing base-mesh bitstream to determine parsed information; generating, using the parsed information, a BaseMeshConfigurationProperty box; and storing the BaseMeshConfigurationProperty box in an ItemPropertyContainerBox of the base-mesh volumetric video media item.

Example 14. The method according to example 13, wherein the storing further comprises: generating, using the parsed information, a BaseMeshConfigurationProperty box containing at least a BaseMeshDecoderConfigurationRecord configuration box.

Example 15. The method according to example 1, wherein the storing further comprises: accessing the attribute information bitstream, the geometry information bitstream, the atlas bitstream, and the base-mesh bitstream; storing the attribute information bitstream in an attribute video media track of the file structure; storing the geometry information bitstream in a geometry video media track of the file structure; storing the atlas information bitstream in an atlas volumetric video media track of the file structure; storing the base-mesh bitstream in more than one base-mesh volumetric video media track of the file structure; and storing the attribute video media track, the geometry video media track, and the atlas volumetric video track, and the more than one base-mesh volumetric video media track as one group of the file structure.

Example 16. The method according to example 15, wherein the storing further comprises: parsing the base-mesh bitstream to determine parsed information; determining, using the parsed information, coded sub-meshes of the base-mesh bitstream, and storing individual coded sub-meshes that have been determined as separate base-mesh volumetric tracks.

Example 17. The method according to any of examples 2 to 9, 15 or 16, further comprising storing parameter sets of the base-mesh bitstream in a V3CDecoderConfigurationRecord in the atlas track.

Example 18. The method according to any of examples 10 to 14, further comprising storing parameter sets of the base-mesh bitstream in a V3CDecoderConfigurationRecord in the item track.

Example 19. The method according to any of examples 2 to 14, wherein a number of syntax elements of syntax structures of parameter sets of a base-mesh sub-bitstream are extracted and stored as variables of a BaseMeshConfigurationRecord.

Example 20. The method according to any of examples 1 to 19, further comprising transmitting the coded bitstream having the video-based dynamic mesh coding and that uses the file structure that is compliant with the international organization for standardization base media file format (ISOBMFF).

Example 21. A method, comprising: receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

Example 22. A computer program, comprising instructions for performing the methods of any of examples 1 to 21, when the computer program is run on an apparatus.

Example 23. The computer program according to example 22, wherein the computer program is a computer program product comprising a computer-readable medium bearing instructions embodied therein for use with the apparatus.

Example 24. The computer program according to example 22, wherein the computer program is directly loadable into an internal memory of the apparatus.

Example 25. An apparatus, comprising means for performing: accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

Example 26. The apparatus according to example 25, wherein the storing comprises: accessing the attribute information bitstream, the geometry information bitstream, the atlas bitstream, and the base-mesh bitstream; storing the attribute information bitstream in an attribute video media track of the file structure; storing the geometry information bitstream in a geometry video media track of the file structure; storing the atlas information bitstream in an atlas volumetric video media track of the file structure; storing the base-mesh bitstream in a base-mesh volumetric video media track of the file structure; and storing the attribute video media track, the geometry video media track, and the atlas volumetric video track, and the base-mesh volumetric video media track as one or more groups of the file structure.

Example 27. The apparatus according to example 26, wherein the storing further comprises: referencing, using corresponding track references, the atlas volumetric video media track to the attribute video media track, the geometry video media track, and the base-mesh volumetric video media track.

Example 28. The apparatus according to example 26, wherein the storing further comprises: detecting coded access units of the base-mesh bitstream; and causing construction and storage of a volumetric video media track in the file structure, wherein the volumetric video media track comprises the one or more samples, wherein individual samples store one coded access unit that was detected from the base-mesh bitstream.

Example 29. The apparatus according to example 28, wherein the storing further comprises: parsing the base-mesh bitstream to determine parsed information; generating, using the parsed information, a BaseMeshSampleEntry sample entry box; and storing the BaseMeshSampleEntry sample entry box in a SampleDescriptionBox of the base-mesh volumetric video media track in the file structure.

Example 30. The apparatus according to example 29, wherein the storing further comprises: generating. using the parsed information, a BaseMeshSampleEntry sample entry box containing at least a BaseMeshConfigurationBox configuration box.

Example 31. The apparatus according to example 28, wherein the storing further comprises: parsing the base-mesh bitstream to determine parsed information; generating, using the parsed information, a BaseMeshSampleEntry sample entry box; generating, using the parsed information, a RestrictedSampleEntry sample entry box; storing the BaseMeshSampleEntry sample entry box in the RestrictedSampleEntry sample entry box; and storing the RestrictedSampleEntry sample entry box of the base-mesh volumetric video media track in the file structure.

Example 32. The apparatus according to example 31, wherein the storing further comprises: determining a V3C unit header associated to the base-mesh bitstream; and storing the V3C unit header in a V3CUnitHeaderBox in SchemeInformationBox present in a RestrictedSchemeInfoBox.

Example 33. The apparatus according to example 28, wherein the storing further comprises: parsing the base-mesh bitstream to determine parsed information; determining coded sub-meshes of the base-mesh bitstream; generating a SubSampleInformationBox sample entry box where one sub-sample corresponds to one coded sub-mesh that was determined from the base-mesh bitstream; and storing the SubSampleInformationBox sample entry box in SampleTableBox table box or TrackFragmentBox fragment box of the base-mesh volumetric video media track.

Example 34. The apparatus according to example 25, wherein the storing further comprises: accessing the attribute information bitstream, the geometry information bitstream, the atlas bitstream, and the base-mesh bitstream; storing the attribute information bitstream in an attribute video media item of the file structure; storing the geometry information bitstream in a geometry video media item of the file structure; storing the atlas information bitstream in an atlas volumetric video media item of the file structure; storing the base-mesh bitstream in a base-mesh volumetric video media item of the file structure; and storing the attribute video media item, the geometry video media item, and the atlas volumetric video item, and the base-mesh volumetric video media item as one or more groups of the file structure.

Example 35. The apparatus according to example 34, wherein the storing further comprises: referencing, using corresponding track references, the atlas volumetric video media item to the attribute video media item, the geometry video media item, and the base-mesh volumetric video media item.

Example 36. The apparatus according to example 34, wherein the storing further comprises: detecting coded access units of base-mesh bitstream; and causing construction and storage of a volumetric video media item in the file structure, wherein the volumetric video media item comprises one coded access unit of the base-mesh bitstream.

Example 37. The apparatus according to example 34, wherein the storing further comprises: parsing base-mesh bitstream to determine parsed information; generating, using the parsed information, a BaseMeshConfigurationProperty box; and storing the BaseMeshConfigurationProperty box in an ItemPropertyContainerBox of the base-mesh volumetric video media item.

Example 38. The apparatus according to example 37, wherein the storing further comprises: generating, using the parsed information, a BaseMeshConfigurationProperty box containing at least a BaseMeshDecoderConfigurationRecord configuration box.

Example 39. The apparatus according to example 25, wherein the storing further comprises: accessing the attribute information bitstream, the geometry information bitstream, the atlas bitstream, and the base-mesh bitstream; storing the attribute information bitstream in an attribute video media track of the file structure; storing the geometry information bitstream in a geometry video media track of the file structure; storing the atlas information bitstream in an atlas volumetric video media track of the file structure; storing the base-mesh bitstream in more than one base-mesh volumetric video media track of the file structure; and storing the attribute video media track, the geometry video media track, and the atlas volumetric video track, and the more than one base-mesh volumetric video media track as one group of the file structure.

Example 40. The apparatus according to example 39, wherein the storing further comprises: parsing the base-mesh bitstream to determine parsed information; determining, using the parsed information, coded sub-meshes of the base-mesh bitstream, and storing individual coded sub-meshes that have been determined as separate base-mesh volumetric tracks.

Example 41. The apparatus according to any of examples 26 to 33, 39 or 40, wherein the means are further configured to perform: storing parameter sets of the base-mesh bitstream in a V3CDecoderConfigurationRecord in the atlas track.

Example 42. The apparatus according to any of examples 34 to 38, wherein the means are further configured to perform: storing parameter sets of the base-mesh bitstream in a V3CDecoderConfigurationRecord in the item track.

Example 43. The apparatus according to any of examples 26 to 38, wherein a number of syntax elements of syntax structures of parameter sets of a base-mesh sub-bitstream are extracted and stored as variables of a BaseMeshConfigurationRecord.

Example 44. The apparatus according to any of examples 25 to 43, wherein the means are further configured to perform: transmitting the coded bitstream having the video-based dynamic mesh coding and that uses the file structure that is compliant with the international organization for standardization base media file format (ISOBMFF).

Example 45. An apparatus, comprising means for performing: receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

Example 46. The apparatus of any preceding apparatus example, wherein the means comprises: at least one processor; and at least one memory storing instructions that, when executed by at least one processor, cause the performance of the apparatus.

Example 47. An apparatus, comprising: one or more processors; and one or more memories storing instructions that, when executed by the one or more processors, cause the apparatus at least to perform: accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and storing, by the apparatus for later transmission, the coded bitstream having the video-based dynamic mesh coding in a file structure compliant with an international organization for standardization base media file format (ISOBMFF).

Example 48. The apparatus according to example 47, wherein the storing comprises: accessing the attribute information bitstream, the geometry information bitstream, the atlas bitstream, and the base-mesh bitstream; storing the attribute information bitstream in an attribute video media track of the file structure; storing the geometry information bitstream in a geometry video media track of the file structure; storing the atlas information bitstream in an atlas volumetric video media track of the file structure; storing the base-mesh bitstream in a base-mesh volumetric video media track of the file structure; and storing the attribute video media track, the geometry video media track, and the atlas volumetric video track, and the base-mesh volumetric video media track as one or more groups of the file structure.

Example 49. The apparatus according to example 48, wherein the storing further comprises: referencing, using corresponding track references, the atlas volumetric video media track to the attribute video media track, the geometry video media track, and the base-mesh volumetric video media track.

Example 50. The apparatus according to example 48, wherein the storing further comprises: detecting coded access units of the base-mesh bitstream; and causing construction and storage of a volumetric video media track in the file structure, wherein the volumetric video media track comprises the one or more samples, wherein individual samples store one coded access unit that was detected from the base-mesh bitstream.

Example 51. The apparatus according to example 50, wherein the storing further comprises: parsing the base-mesh bitstream to determine parsed information; generating, using the parsed information, a BaseMeshSampleEntry sample entry box; and storing the BaseMeshSampleEntry sample entry box in a SampleDescriptionBox of the base-mesh volumetric video media track in the file structure.

Example 52. The apparatus according to example 51, wherein the storing further comprises: generating. using the parsed information, a BaseMeshSampleEntry sample entry box containing at least a BaseMeshConfigurationBox configuration box.

Example 53. The apparatus according to example 50, wherein the storing further comprises: parsing the base-mesh bitstream to determine parsed information; generating, using the parsed information, a BaseMeshSampleEntry sample entry box; generating, using the parsed information, a RestrictedSampleEntry sample entry box; storing the BaseMeshSampleEntry sample entry box in the RestrictedSampleEntry sample entry box; and storing the RestrictedSampleEntry sample entry box of the base-mesh volumetric video media track in the file structure.

Example 54. The apparatus according to example 53, wherein the storing further comprises: determining a V3C unit header associated to the base-mesh bitstream; and storing the V3C unit header in a V3CUnitHeaderBox in SchemeInformationBox present in a RestrictedSchemeInfoBox.

Example 55. The apparatus according to example 50, wherein the storing further comprises: parsing the base-mesh bitstream to determine parsed information; determining coded sub-meshes of the base-mesh bitstream; generating a SubSampleInformationBox sample entry box where one sub-sample corresponds to one coded sub-mesh that was determined from the base-mesh bitstream; and storing the SubSampleInformationBox sample entry box in SampleTableBox table box or TrackFragmentBox fragment box of the base-mesh volumetric video media track.

Example 56. The apparatus according to example 47, wherein the storing further comprises: accessing the attribute information bitstream, the geometry information bitstream, the atlas bitstream, and the base-mesh bitstream; storing the attribute information bitstream in an attribute video media item of the file structure; storing the geometry information bitstream in a geometry video media item of the file structure; storing the atlas information bitstream in an atlas volumetric video media item of the file structure; storing the base-mesh bitstream in a base-mesh volumetric video media item of the file structure; and storing the attribute video media item, the geometry video media item, and the atlas volumetric video item, and the base-mesh volumetric video media item as one or more groups of the file structure.

Example 57. The apparatus according to example 56, wherein the storing further comprises: referencing, using corresponding track references, the atlas volumetric video media item to the attribute video media item, the geometry video media item, and the base-mesh volumetric video media item.

Example 58. The apparatus according to example 56, wherein the storing further comprises: detecting coded access units of base-mesh bitstream; and causing construction and storage of a volumetric video media item in the file structure, wherein the volumetric video media item comprises one coded access unit of the base-mesh bitstream.

Example 59. The apparatus according to example 56, wherein the storing further comprises: parsing base-mesh bitstream to determine parsed information; generating, using the parsed information, a BaseMeshConfigurationProperty box; and storing the BaseMeshConfigurationProperty box in an ItemPropertyContainerBox of the base-mesh volumetric video media item.

Example 60. The apparatus according to example 59, wherein the storing further comprises: generating, using the parsed information, a BaseMeshConfigurationProperty box containing at least a BaseMeshDecoderConfigurationRecord configuration box.

Example 61. The apparatus according to example 47, wherein the storing further comprises: accessing the attribute information bitstream, the geometry information bitstream, the atlas bitstream, and the base-mesh bitstream; storing the attribute information bitstream in an attribute video media track of the file structure; storing the geometry information bitstream in a geometry video media track of the file structure; storing the atlas information bitstream in an atlas volumetric video media track of the file structure; storing the base-mesh bitstream in more than one base-mesh volumetric video media track of the file structure; and storing the attribute video media track, the geometry video media track, and the atlas volumetric video track, and the more than one base-mesh volumetric video media track as one group of the file structure.

Example 62. The apparatus according to example 61, wherein the storing further comprises: parsing the base-mesh bitstream to determine parsed information; determining, using the parsed information, coded sub-meshes of the base-mesh bitstream, and storing individual coded sub-meshes that have been determined as separate base-mesh volumetric tracks.

Example 63. The apparatus according to any of examples 48 to 55, 61 or 62, wherein the one or more memories further store instructions that, when executed by the one or more processors, cause the apparatus at least to perform: storing parameter sets of the base-mesh bitstream in a V3CDecoderConfigurationRecord in the atlas track.

Example 64. The apparatus according to any of examples 56 to 60, wherein the one or more memories further store instructions that, when executed by the one or more processors, cause the apparatus at least to perform: storing parameter sets of the base-mesh bitstream in a V3CDecoderConfigurationRecord in the item track.

Example 65. The apparatus according to any of examples 48 to 60, wherein a number of syntax elements of syntax structures of parameter sets of a base-mesh sub-bitstream are extracted and stored as variables of a BaseMeshConfigurationRecord.

Example 66. The apparatus according to any of examples 47 to 65, wherein the one or more memories further store instructions that, when executed by the one or more processors, cause the apparatus at least to perform: transmitting the coded bitstream having the video-based dynamic mesh coding and that uses the file structure that is compliant with the international organization for standardization base media file format (ISOBMFF).

Example 67. An apparatus, comprising: one or more processors; and one or more memories storing instructions that, when executed by the one or more processors, cause the apparatus at least to perform: receiving, by an apparatus performing a decoding process, a file structure compliant with an international organization for standardization base media file format (ISOBMFF) that stores a coded bitstream having video-based dynamic mesh coding; parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream; performing, by the apparatus, decoding with at least the base-mesh bitstream to recreate media; and storing or outputting for display, by the apparatus, the recreated media.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 11. A computer-readable medium may comprise a computer-readable storage medium (e.g., memories 925 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two dimensional
3D three dimensional
4CC or fourCC four-character code
AVC advanced video coding
BMCL Base-mesh Coding Layer
CfP call for proposal
CVS coded V3C sequence
DASH Dynamic Adaptive Streaming over Hypertext Transfer Protocol
FoV field of view
ftyp File TypeBox
GOP group of pictures
H.264/AVC Advanced video coding, where H.264 is a video coding/compression standard
HEIF High Efficiency Image File Format
HEVC High Efficiency Video Coding
HTTP Hypertext Transfer Protocol
ID identification
ISOBMFF ISO base media file format
ISO/IEC International Organization for Standardization/International Electrotechnical Commission
mdat MediaDataBox
MIV MPEG immersive video
MPEG Motion picture experts group
MPEG-DASH MPEG-Dynamic Adaptive Streaming over Hypertext Transfer Protocol
moof movie fragment box
moov MovieBox
NAL network abstraction layer
RBSP raw byte sequence payload
RGBA red green blue alpha (where A=alpha channel)
RGB (D) red, green, blue, and optionally depth
resv restricted video
SAP stream access point
SEI supplemental enhancement information
SVC scalable video coding
sync synchronized
trak TrackBox
V3C Visual volumetric video-based coding
V-DMC Video-based dynamic mesh coding
V-PCC Video-based point cloud compression
VPS V3C parameter set
WD working draft

What is claimed is:

1. A method comprising:
accessing, by an apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and
storing, by the apparatus for later transmission, the coded bitstream having the video-based dynamic mesh coding in a file structure compliant with an international organization for standardization base media file format (ISOBMFF).

2. An apparatus, comprising:
one or more processors; and
one or more memories storing instructions that, when executed by the one or more processors, cause the apparatus at least to perform:
accessing, by the apparatus performing an encapsulation process, a coded bitstream having video-based dynamic mesh coding, wherein the coded bitstream comprises an attribute information bitstream, a geometry information bitstream, an atlas bitstream, and a base-mesh bitstream; and
storing, by the apparatus for later transmission, the coded bitstream having the video-based dynamic mesh coding in a file structure compliant with an international organization for standardization base media file format (ISOBMFF).

3. The apparatus according to claim 2, wherein the storing comprises:
accessing the attribute information bitstream, the geometry information bitstream, the atlas bitstream, and the base-mesh bitstream;
storing the attribute information bitstream in an attribute video media track of the file structure;
storing the geometry information bitstream in a geometry video media track of the file structure;
storing the atlas bitstream in an atlas volumetric video media track of the file structure;
storing the base-mesh bitstream in a base-mesh volumetric video media track of the file structure; and
storing the attribute video media track, the geometry video media track, and the atlas volumetric video media track, and the base-mesh volumetric video media track as one or more groups of the file structure.

4. The apparatus according to claim 3, wherein the storing further comprises:
referencing, using corresponding track references, the atlas volumetric video media track to the attribute video media track, the geometry video media track, and the base-mesh volumetric video media track.

5. The apparatus according to claim 3, wherein the storing further comprises:
detecting coded access units of the base-mesh bitstream; and
causing construction and storage of a volumetric video media track in the file structure, wherein the volumetric video media track comprises one or more samples, wherein individual samples store one coded access unit that was detected from the base-mesh bitstream.

6. The apparatus according to claim 5, wherein the storing further comprises:
parsing the base-mesh bitstream to determine parsed information;
generating, using the parsed information, a BaseMeshSampleEntry sample entry box; and
storing the BaseMeshSampleEntry sample entry box in a SampleDescriptionBox of the base-mesh volumetric video media track in the file structure.

7. The apparatus according to claim 6, wherein the storing further comprises:
generating. using the parsed information, a BaseMeshSampleEntry sample entry box containing at least a BaseMeshConfigurationBox configuration box.

8. The apparatus according to claim 5, wherein the storing further comprises:
parsing the base-mesh bitstream to determine parsed information;
generating, using the parsed information, a BaseMeshSampleEntry sample entry box;
generating, using the parsed information, a RestrictedSampleEntry sample entry box;
storing the BaseMeshSampleEntry sample entry box in the RestrictedSampleEntry sample entry box; and
storing the RestrictedSampleEntry sample entry box of the base-mesh volumetric video media track in the file structure.

9. The apparatus according to claim 8, wherein the storing further comprises:
determining a V3C unit header associated to the base-mesh bitstream; and
storing the V3C unit header in a V3CUnitHeaderBox in SchemeInformationBox present in a RestrictedSchemeInfoBox.

10. The apparatus according to claim 5, wherein the storing further comprises:
parsing the base-mesh bitstream to determine parsed information;
determining coded sub-meshes of the base-mesh bitstream;
generating a SubSampleInformationBox sample entry box where one sub-sample corresponds to one coded sub-mesh that was determined from the base-mesh bitstream; and
storing the SubSampleInformationBox sample entry box in SampleTableBox table box or TrackFragmentBox fragment box of the base-mesh volumetric video media track.

11. The apparatus according to claim 2, wherein the storing further comprises:
accessing the attribute information bitstream, the geometry information bitstream, the atlas bitstream, and the base-mesh bitstream;
storing the attribute information bitstream in an attribute video media item of the file structure;
storing the geometry information bitstream in a geometry video media item of the file structure;
storing the atlas information bitstream in an atlas volumetric video media item of the file structure;
storing the base-mesh bitstream in a base-mesh volumetric video media item of the file structure; and
storing the attribute video media item, the geometry video media item, and the atlas volumetric video item, and the base-mesh volumetric video media item as one or more groups of the file structure.

12. The apparatus according to claim 11, wherein the storing further comprises:
referencing, using corresponding track references, the atlas volumetric video media item to the attribute video media item, the geometry video media item, and the base-mesh volumetric video media item.

13. The apparatus according to claim 11, wherein the storing further comprises:
detecting coded access units of base-mesh bitstream; and
causing construction and storage of a volumetric video media item in the file structure, wherein the volumetric video media item comprises one coded access unit of the base-mesh bitstream.

14. The apparatus according to claim 11, wherein the storing further comprises:
parsing base-mesh bitstream to determine parsed information;
generating, using the parsed information, a BaseMeshConfigurationProperty box; and
storing the BaseMeshConfigurationProperty box in an ItemPropertyContainerBox of the base-mesh volumetric video media item.

15. The apparatus according to claim 14, wherein the storing further comprises:
generating, using the parsed information, a BaseMeshConfigurationProperty box containing at least a BaseMeshDecoderConfigurationRecord configuration box.

16. The apparatus according to claim 2, wherein the storing further comprises:
accessing the attribute information bitstream, the geometry information bitstream, the atlas bitstream, and the base-mesh bitstream;
storing the attribute information bitstream in an attribute video media track of the file structure;
storing the geometry information bitstream in a geometry video media track of the file structure;
storing the atlas information bitstream in an atlas volumetric video media track of the file structure;
storing the base-mesh bitstream in more than one base-mesh volumetric video media track of the file structure; and
storing the attribute video media track, the geometry video media track, and the atlas volumetric video track, and the more than one base-mesh volumetric video media track as one group of the file structure.

17. The apparatus according to claim 16, wherein the storing further comprises:
parsing the base-mesh bitstream to determine parsed information;
determining, using the parsed information, coded sub-meshes of the base-mesh bitstream, and
storing individual coded sub-meshes that have been determined as separate base-mesh volumetric tracks.

18. The apparatus according to claim 11, wherein the one or more memories further store instructions that, when executed by the one or more processors, cause the apparatus at least to perform: storing parameter sets of the base-mesh bitstream in a V3CDecoderConfigurationRecord in the item track.

19. The apparatus according to claim 3, wherein a number of syntax elements of syntax structures of parameter sets of a base-mesh sub-bitstream are extracted and stored as variables of a BaseMeshConfigurationRecord.

20. An apparatus, comprising:
one or more processors; and
one or more memories storing instructions that, when executed by the one or more processors, cause the apparatus at least to perform:
receiving, by an apparatus performing a decoding process, a file structure compliant with an international organization for standardization base media file format (ISOBMFF) that stores a coded bitstream having video-based dynamic mesh coding;
parsing, by the apparatus, the received file structure to extract the coded bitstream having the video-based dynamic mesh coding, the coded bitstream comprising an attribute information bitstream, a geometry information bitstream, an atlas bitstream, and a base-mesh bitstream;
performing, by the apparatus, decoding with at least the base-mesh bitstream to recreate media; and
storing or outputting for display, by the apparatus, the recreated media.
